(19) United States
(12) Patent Application Publication
(10) Pub. No.: US 2024/0279083 A1
(43) Pub. Date: Aug. 22, 2024

(54) WATER TREATMENT DEVICE BASED ON MAGNETIC FIELDS APPLICATION

(71) Applicant: Alireza Fadaee Outan, Tehran (IR)

(72) Inventor: Alireza Fadaee Outan, Tehran (IR)

(21) Appl. No.: 18/571,278

(22) PCT Filed: Jun. 20, 2021
(86) PCT No.: PCT/IB2021/055418

§ 371 Date: Dec. 18, 2023

(51) Int. Cl. C02F 1/48

(52) U.S. Cl. CPC C02F 1/482; C02F 2201/48; C02F 2303/04

(57) ABSTRACT

A system for magnetizing water may include a non-magnetic conduit that may be configured to allow a stream of water to flow through the system, and a magnetic fields generation mechanism that may be configured to subject the stream of water to magnetic fields. The magnetic fields generation mechanism may include a plurality of magnets arranged around the non-magnetic conduit.

### TECHNICAL FIELD

The present disclosure generally relates to non-chemical water treatment systems and methods. Particularly, the present disclosure relates to a system and method for magnetization of water by passing a stream of water through at least one magnetic field to affect intramolecular bonds of water.

### BACKGROUND

Exposing water molecules to a magnetic field may lead to changes in water in terms of nature and physical shape, such that hydrogen bond between water molecules may weaken under the influence of a magnetic field. Consequently, chemical and physical features of water may be improved by subjecting the water to the magnetic influence of at least one magnetic field with a certain arrangement. Such water which has been treated with magnetic fields may be referred to as a magnetized water. When water molecule is exposed to a magnetic field, the water molecule may undergo some changes in terms of physical shape, which may lead to an increase in the solubility and porousness of water. As used herein, porousness of water may refer to the ability of water for dispersion and penetration into other materials. Such increase in solubility may contribute to the dissolution of nutritious substances as well as water's penetration ability and penetration rate into nutritious substances in the cells of plants and animals.

U.S. Pat. No. 5,009,791 discloses a magnetic treatment unit that includes an elongated permanent magnet with six poles. The aforementioned magnet is covered by an inner casing of copper or another non-magnetic material which protects the magnet against attack by the water flowing through the unit. Two stream-lined covers are attached to the ends of the aforementioned magnet and casing. An outer, tubular casing of a magnetic material, such a steel, surrounds the magnet and the inner casing in concentric alignment forming an annular water duct between the two casings. The outer casing is fastened in two ends fitting by means of screw thread, these fittings serving for connecting the unit to an inlet and outlet pipe, respectively. An outer shell of copper or another non-magnetic material connects the two end fittings and protects the entire unit against mechanical damage, while being spaced apart from the outer magnetic casing and forming an air space there between.

WO 2015186176 A1 discloses a method and a device for the manufacturing of magnetized water is presented. A disc-shaped rotator is connected to a motor via a rotation shaft. The rotator includes multiple permanent magnets fixed at a selected interval therewithin. Magnetized water may be produced by rotating the rotator at high speed using the rotation shaft that is connected to the motor and applying an alternating magnetic field on the water flowing through the device.

U.S. Pat. No. 6,773,602 discloses a method for production of magnetized water wherein water containers have two coils around and with the help of cooling structure, water inside container is constantly cooled. The transmitted wave form can affect the quality of structural changes in magnetized water.

US 2009/0206020 A1 discloses a device that may include a chamber for placing a container of purified water, where the chamber may be wound with coils of wire with a predetermined number of rounds. The disclosed device may further include a means of supplying power to convert originally supplied alternating current of electricity into pulsating direct current signals and impress them on the coils for induction of a pulsating magnetic field to the chamber, a means of cooling the chamber, a means of sensing changes in temperature of the coils, a means of measuring time to gauge the time of magnetization of the purified water, and a means of control to stop input of direct current pulsating signals when the time spent on magnetizing has reached a preset time.

CN02131922 discloses a structure for the production of magnetized water in which a hidden spiral in the pipe enables the magnets to locate themselves with opposite poles next to each other and penetrate to the core of screw. In the meantime, water rotates around the core while passing through the device and this causes existing particles interact constantly with magnetic field and clusters or change to sole water molecules under ideal conditions. Other relevant disclosures are CN201770526U, CN101905915A, CN2082719U, GB1108308A, US20090065438A1, KR20040057857A, and U.S. Pat. No. 4,935,133A.

The arrangement of magnetic fields through which water is to flow has a significant effect on chemical and physical features of water. Consequently, finding an arrangement that may allow for a better improvement of chemical and physical features of water is crucial in the field.

### SUMMARY OF DISCLOSURE

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to a system for magnetizing water. An exemplary system for magnetizing water may include a non-magnetic conduit that may be configured to allow a stream of water to flow through an exemplary system, and a magnetic fields generation mechanism that may be configured to subject the stream of water to magnetic fields. An exemplary magnetic fields generation mechanism may include a plurality of magnets arranged around the non-magnetic conduit.

An exemplary magnetic field generation mechanism may include a plurality of axially magnetized permanent magnet rings. Each exemplary permanent magnet ring may be fitted coaxially around an exemplary non-magnetic conduit. The plurality of exemplary axially magnetized permanent magnet rings may be mounted along a length of an exemplary non-magnetic conduit with a predetermined longitudinal distance between each pair of adjacent exemplary axially magnetized permanent magnet rings of the plurality of axially magnetized permanent magnet rings.

In an exemplary embodiment, the plurality of axially magnetized permanent magnet rings may be mounted on the non-magnetic conduit with an axis of symmetry of each axially magnetized permanent magnet ring of the plurality of axially magnetized permanent magnet rings parallel with a longitudinal axis of the non-magnetic conduit. A central hole of each axially magnetized permanent magnet ring of the plurality of axially magnetized permanent magnet rings may encompass the non-magnetic conduit.

In an exemplary embodiment, each axially magnetized permanent magnet ring of the plurality of axially magnetized permanent magnet rings may include a first face with a first polarity and a second face with a second polarity. The first face and the second face may be perpendicular to the axis of symmetry of the permanent magnet ring.

In an exemplary embodiment, each pair of adjacent axially magnetized permanent magnet rings of the plurality of axially magnetized permanent magnet rings may be facing each other with faces having opposite polarities.

In an exemplary embodiment, each pair of adjacent axially magnetized permanent magnet rings of the plurality of axially magnetized permanent magnet rings may be facing each other with faces having similar polarities.

In an exemplary embodiment, the plurality of axially magnetized permanent magnet rings may include a first axially magnetized permanent magnet ring, and a second axially magnetized permanent magnet ring that may be positioned at the predetermined longitudinal distance away from the first axially magnetized permanent magnet ring. A first face of the first axially magnetized permanent magnet ring with a first polarity may be positioned facing a second face of the second axially magnetized permanent magnet ring with a second polarity. The first polarity and the second polarity may be opposite polarities.

In an exemplary embodiment, an inner diameter of each axially magnetized permanent magnet ring of the plurality of axially magnetized permanent magnet rings may be equal to an outer diameter of the non-magnetic conduit.

An exemplary system may further include an elongated housing that may be coaxially disposed around the non-magnetic conduit. An exemplary elongated housing may be extended along the longitudinal axis of an exemplary non-magnetic conduit. An exemplary elongated housing may be coaxial with and encompassing the plurality of axially magnetized permanent magnet rings such that the plurality of axially magnetized permanent magnet rings are disposed between the elongated housing and the non-magnetic conduit.

In an exemplary embodiment, the magnetic field generation mechanism may include a plurality of slab magnets that may be arranged around an exemplary non-magnetic conduit. Exemplary plurality of slab magnets may be mounted along a length of an exemplary non-magnetic conduit with a predetermined longitudinal distance between each pair of adjacent slab magnets of the plurality of slab magnets.

In an exemplary embodiment, each slab magnet of the plurality of slab magnets may be mounted between an outer surface of the non-magnetic conduit and an inner surface of an iron shield.

In an exemplary embodiment, the plurality of slab magnets may include pairs of slab magnets that may be mounted on opposite sides of the outer surface of the non-magnetic conduit with each pair of oppositely mounted slab magnets facing each other with opposite poles.

In an exemplary embodiment, the magnetic field generation mechanism may include a plurality of magnet bars that may be arranged around the non-magnetic conduit. The plurality of magnet bars may be mounted along a length of the non-magnetic conduit with a predetermined longitudinal distance between each pair of adjacent magnet bars of the plurality of magnet bars.

In an exemplary embodiment, the magnetic field generation mechanism may include a plurality of electromagnet coils that may be arranged around the non-magnetic conduit. The plurality of electromagnet coils may be mounted along a length of the non-magnetic conduit with a predetermined longitudinal distance between each pair of adjacent electromagnet coils of the plurality of electromagnet coils.

### BRIEF DESCRIPTION OF FIGURES

The novel features which are believed to be characteristic of the present disclosure, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1A illustrates a system for magnetizing water utilizing ring magnets, consistent with one or more exemplary embodiments of the present disclosure;

FIG. 1B illustrates a schematic sectional front view of a system for magnetizing water utilizing ring magnets, consistent with one or more exemplary embodiments of the present disclosure;

FIG. 2 illustrates a schematic perspective view of an axially magnetized permanent magnet ring, consistent with one or more exemplary embodiments of the present disclosure;

FIG. 3A illustrates magnetic field lines generated by a plurality of axially magnetized permanent magnet rings with each pair of adjacent axially magnetized permanent magnet rings facing each other with faces having similar polarities, consistent with one or more exemplary embodiments of the present disclosure;

FIG. 3B illustrates magnetic field lines generated by a plurality of axially magnetized permanent magnet rings with each pair of adjacent axially magnetized permanent magnet rings facing each other with faces having opposite polarities, consistent with one or more exemplary embodiments of the present disclosure;

FIG. 4A illustrates a schematic sectional side view of a system for magnetizing water utilizing slab magnets, consistent with one or more exemplary embodiments of the present disclosure;

FIG. 4B illustrates a schematic sectional front view of a system for magnetizing water utilizing slab magnets, consistent with one or more exemplary embodiments of the present disclosure;

FIG. 5A illustrates a schematic sectional side view of a system for magnetizing water utilizing bar magnets, consistent with one or more exemplary embodiments of the present disclosure;

FIG. 5B illustrates a schematic sectional front view of a system for magnetizing water utilizing bar magnets, consistent with one or more exemplary embodiments of the present disclosure;

FIG. 6 illustrates a schematic sectional side view of a system for magnetizing water utilizing at least one electromagnet, consistent with one or more exemplary embodiments of the present disclosure; and

FIG. 7 illustrates a flow diagram of a water disinfectant production system 70, consistent with one or more exemplary embodiments of the present disclosure.

### DETAILED DESCRIPTION

The novel features which are believed to be characteristic of the present disclosure, as to its structure, organization, use and method of operation, together with further objectives and advantages thereof, will be better understood from the following discussion.

According to one or more exemplary embodiments, the present disclosure is directed to systems and methods for magnetizing water. An exemplary system for magnetizing water may include a non-magnetic conduit or pie, through which water may be pumped. An exemplary system may further include a magnetic fields generation mechanism that may be coupled with an exemplary non-magnetic conduit. An exemplary magnetic fields generation mechanism may be configured to apply at least one magnetic field to an exemplary stream of water flowing through an exemplary non-magnetic conduit. For example, an exemplary magnetic fields generation mechanism may include a plurality of axially magnetized permanent magnet rings, where each permanent magnet ring may be fitted coaxially around the non-magnetic conduit. In another example, an exemplary magnetic field generation mechanism may include a plurality of slab magnets or a plurality of magnet bars that may be arranged around an exemplary non-magnetic conduit. In yet another example, an exemplary magnetic field generation mechanism may include at least one electromagnet coil wound around an exemplary non-magnetic conduit.

In an exemplary embodiment, such application of at least one magnetic field on an exemplary stream of water passing through an exemplary non-magnetic conduit of an exemplary system for producing magnetized water may change the properties of water by affecting hydrogen bonds of water molecules. Consequently, the produced magnetized water may have improved stability and solubility in comparison with normal water.

In an exemplary embodiment, magnetized water that may be produced by exemplary systems and methods may be utilized for cultivating organic products without using fertilizers. Due to more solubility of magnetized water and its combination with soil, minerals in soil are better absorbed by plant and this causes better resistance and growth of plant and need less fertilizer. Magnetized water in agriculture causes the liberation and increase of solubility of nutritious elements of soil. Generally, small percentage of added fertilizer is used by plant and the rest destroys the soil whereas all the fertilizer is consumed in the soil if magnetized water is used. Due to higher resistance and better growth of plant, more conservation in use of pesticides and agricultural toxins is possible. Furthermore, the issue of sediments in the pipelines of pressurized irrigation and heating systems may be addressed by utilizing magnetized water in these systems rather than normal water. What follows is a through description of various embodiments of systems and methods for magnetizing water.

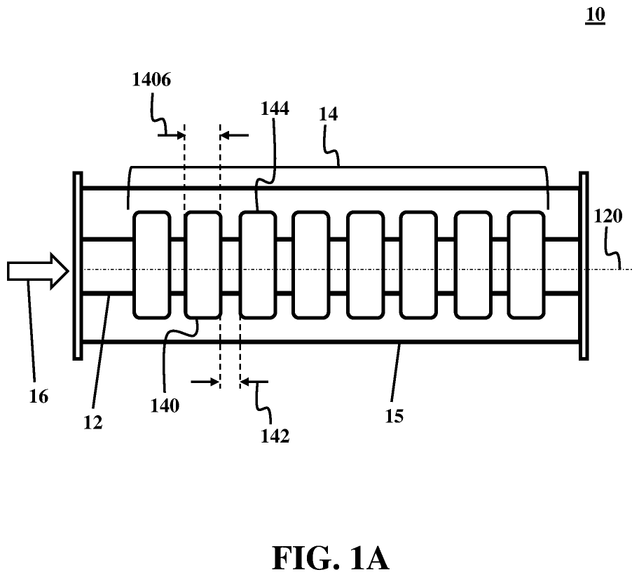

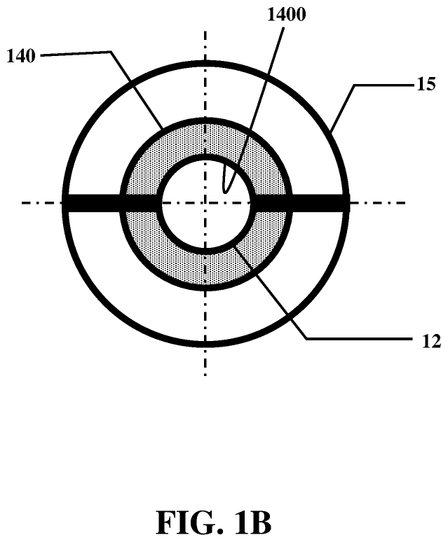

FIG. 1A illustrates a system 10 for magnetizing water utilizing ring magnets, consistent with one or more exemplary embodiments of the present disclosure. FIG. 1B illustrates a schematic sectional front view of system 10 for magnetizing water utilizing ring magnets, consistent with one or more exemplary embodiments of the present disclosure.

In an exemplary embodiment, system 10 may include a non-magnetic conduit 12 and a plurality of axially magnetized permanent magnet rings 14 that may be mounted coaxially around non-magnetic conduit 12. In an exemplary embodiment, plurality of axially magnetized permanent magnet rings 14 may be mounted along a length of non-magnetic conduit 12 with a predetermined longitudinal distance between each pair of adjacent axially magnetized permanent magnet rings of plurality of axially magnetized permanent magnet rings 14. For example, axially magnetized permanent magnet ring 140 may be mounted at a predetermined longitudinal distance 142 from axially magnetized permanent magnet ring 144. In an exemplary embodiment, plurality of axially magnetized permanent magnet rings 14 may be mounted on non-magnetic conduit 12 with an axis of symmetry of each axially magnetized permanent magnet ring of plurality of axially magnetized permanent magnet rings 14 being parallel with a longitudinal axis 120 of non-magnetic conduit 12. In an exemplary embodiment, a central hole of each axially magnetized permanent magnet ring of plurality of axially magnetized permanent magnet rings 14 may encompass non-magnetic conduit 12. For example, central hole 1400 of axially magnetized permanent magnet ring 140 may encompass non-magnetic conduit 12. As used herein, central hole 1400 of axially magnetized permanent magnet ring 140 encompassing non-magnetic conduit 12 may refer to non-magnetic conduit 12 passing through central hole 1400.

In an exemplary embodiment, system 10 may further include an elongated housing 15 that may be coaxially disposed around non-magnetic conduit 12. In an exemplary embodiment, elongated housing 15 may extend along longitudinal axis 120 of non-magnetic conduit 12. Elongated housing 15 may be coaxial with and encompassing plurality of axially magnetized permanent magnet rings 14 such that plurality of axially magnetized permanent magnet rings 14 may be disposed between elongated housing 15 and non-magnetic conduit 12.

In an exemplary embodiment, feed water 16 may be transferred into system 10 via non-magnetic conduit 12. Then, the stream of water passing through system 10 may be subjected to magnetic fields generated by plurality of axially magnetized permanent magnet rings 14. After passing through the magnetic field or fields provided by plurality of axially magnetized permanent magnet rings 14, the produced magnetized water may be fed into other systems or processes to be used as a solvent or other possible applications.

In an exemplary embodiment, the predetermined longitudinal distance between each pair of adjacent axially magnetized permanent magnet rings may be between 0.25 and 1 times the width of each axially magnetized permanent magnet ring. For example, predetermined longitudinal distance 142 between axially magnetized permanent magnet ring 140 and axially magnetized permanent magnet ring 144 may be between 0.25 and 1 times a width 1406 of axially magnetized permanent magnet ring 140. In an exemplary embodiment, plurality of axially magnetized permanent magnet rings 14 may be structured similarly with similar widths.

In an exemplary embodiment, non-magnetic conduit 12 may include a non-magnetic pipe, through which water feed 16 may be pumped into system 10. Water may be supplied from a pressurized source and may flow through system 10 to be magnetized.

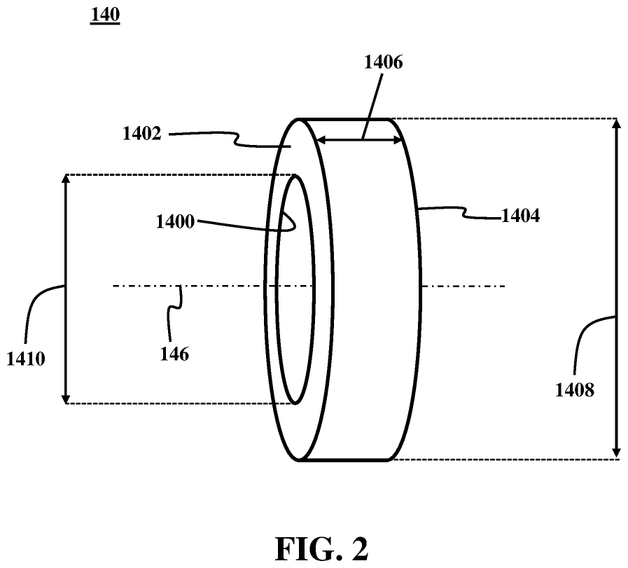

FIG. 2 illustrates a schematic perspective view of axially magnetized permanent magnet ring 140, consistent with one or more exemplary embodiments of the present disclosure. In an exemplary embodiment, each axially magnetized permanent magnet ring of plurality of axially magnetized permanent magnet rings 14 may include a first face with a first polarity and a second face with a second polarity, where the first face and the second face may be perpendicular to an axis of symmetry of each axially magnetized permanent magnet ring of plurality of axially magnetized permanent magnet rings 14. For example, axially magnetized permanent magnet ring 140 may include a first face 1402 with a first polarity and a second face 1404 with a second polarity, where first face 1402 and second face 1404 may be perpendicular to axis of symmetry 146 of axially magnetized permanent magnet ring 140. In an exemplary embodiment, the first polarity may be one of north (N) or south (S) and the second polarity may be one of N or S. As used herein, permanent magnet ring 140 being axially magnetized may refer to first face 1402 having a first polarity, for example N, and second face 1404 having an opposite polarity, for example S.

In an exemplary embodiment, each pair of adjacent axially magnetized permanent magnet rings of plurality of axially magnetized permanent magnet rings 14 may be facing each other with faces having opposite polarities. For example, axially magnetized permanent magnet ring 140 may face axially magnetized permanent magnet ring 144 with faces with opposite polarities, i.e., axially magnetized permanent magnet ring 140 may face axially magnetized permanent magnet ring 144 with a face of N polarity, while axially magnetized permanent magnet ring 144 faces axially magnetized permanent magnet ring 140 with a face of S polarity or vice versa.

In an exemplary embodiment, each pair of adjacent axially magnetized permanent magnet rings of plurality of axially magnetized permanent magnet rings 14 may be facing each other with faces having similar polarities. For example, axially magnetized permanent magnet ring 140 may face axially magnetized permanent magnet ring 144 with faces with similar polarities, i.e., axially magnetized permanent magnet ring 140 may face axially magnetized permanent magnet ring 144 with a face of N polarity, and axially magnetized permanent magnet ring 144 may also face axially magnetized permanent magnet ring 140 with a face of N polarity.

In an exemplary embodiment, a first portion of plurality of axially magnetized permanent magnet rings 14 may be configured such that each pair of adjacent axially magnetized permanent magnet rings of the first portion of plurality of axially magnetized permanent magnet rings 14 may be facing each other with faces having similar polarities. In an exemplary embodiment, a second portion of plurality of axially magnetized permanent magnet rings 14 may be configured such that each pair of adjacent axially magnetized permanent magnet rings of the second portion of plurality of axially magnetized permanent magnet rings 14 may be facing each other with faces having opposite polarities. In an exemplary embodiment, such arrangement may be vice versa, i.e. each pair of adjacent axially magnetized permanent magnet rings of the first portion of plurality of axially magnetized permanent magnet rings 14 may be facing each other with faces having opposite polarities while each pair of adjacent axially magnetized permanent magnet rings of the second portion of plurality of axially magnetized permanent magnet rings 14 may be facing each other with faces having similar polarities.

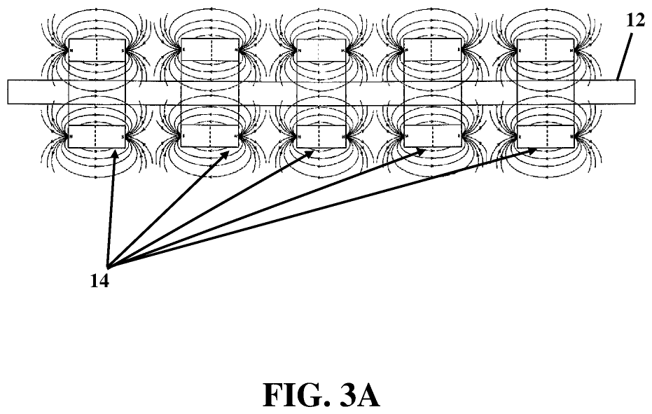

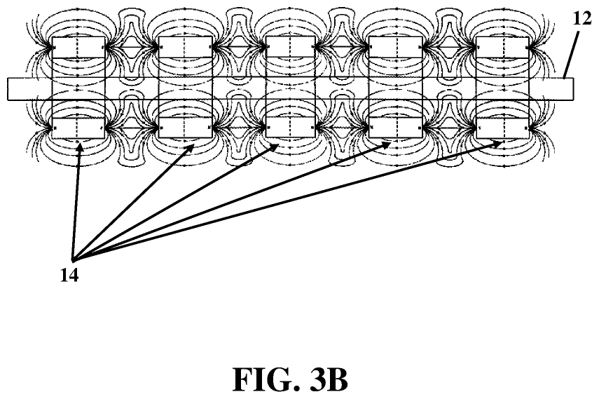

FIG. 3A illustrates magnetic field lines generated by plurality of axially magnetized permanent magnet rings 14 with each pair of adjacent axially magnetized permanent magnet rings facing each other with faces having similar polarities, consistent with one or more exemplary embodiments of the present disclosure. FIG. 3B illustrates magnetic field lines generated by plurality of axially magnetized permanent magnet rings 14 with each pair of adjacent axially magnetized permanent magnet rings facing each other with faces having opposite polarities, consistent with one or more exemplary embodiments of the present disclosure.

In an exemplary embodiment, plurality of axially magnetized permanent magnet rings 14 may include a first axially magnetized permanent magnet ring such as axially magnetized permanent magnet ring 140 and a second axially magnetized permanent magnet ring such as axially magnetized permanent magnet ring 144 that may be positioned at a predetermined longitudinal distance such as predetermined longitudinal distance 142 away from the first axially magnetized permanent magnet ring. In an exemplary embodiment, a first face of the first axially magnetized permanent magnet ring with a first polarity (either S or N) may be positioned facing a second face of the second axially magnetized permanent magnet ring with a second polarity (either S or N). In an exemplary embodiment, the first polarity and the second polarity may be opposite polarities. In an exemplary embodiment, the first polarity and the second polarity may be similar polarities.

In an exemplary embodiment, a predetermined longitudinal distance between each pair of adjacent axially magnetized permanent magnet rings of plurality of axially magnetized permanent magnet rings 14 may be between 2 mm and 10 mm. For example, longitudinal distance 142 between axially magnetized permanent magnet ring 140 and axially magnetized permanent magnet ring 144 may be between 2 mm and 10 mm.

In an exemplary embodiment, a thickness of each axially magnetized permanent magnet ring of plurality of axially magnetized permanent magnet rings 14 may be between 5 mm and 50 mm. For example, a thickness 1406 of axially magnetized permanent magnet ring 140 may be between 5 mm and 50 mm.

In an exemplary embodiment, an outer diameter of each axially magnetized permanent magnet ring of plurality of axially magnetized permanent magnet rings 14 may be between 10 mm and 300 mm. For example, an outer diameter 1408 of axially magnetized permanent magnet ring 140 may be between 10 mm and 300 mm.

In an exemplary embodiment, an inner diameter of each axially magnetized permanent magnet ring of plurality of axially magnetized permanent magnet rings 14 may be equal to an outer diameter 122 of non-magnetic conduit 12. For example, an inner diameter 1410 of axially magnetized permanent magnet ring 140 may be equal to an outer diameter 122 of non-magnetic conduit 12. In an exemplary embodiment, inner diameter 1410 of axially magnetized permanent magnet ring 140 may be in a range of 5 mm to 150 mm.

According to one or more exemplary embodiments, the present disclosure is further directed to a system for magnetizing water, in which magnetic field generation mechanism may include a plurality of slab magnets disposed between each side of a non-magnetic conduit and an outer housing or conduit encompassing the plurality of slab magnets. Exemplary slab magnets may be arranged at both sides of an exemplary non-magnetic conduit along a longitudinal axis of an exemplary non-magnetic conduit. In an exemplary embodiment, exemplary slab magnets may be arranged around an exemplary non-magnetic conduit, such that a pair of slab magnets of exemplary slab magnets may be aligned at opposite sides of an exemplary non-magnetic conduit along an axis perpendicular to an exemplary longitudinal axis of an exemplary non-magnetic conduit. In an exemplary embodiment, exemplary slab magnets may be arranged such that every other pair of slab magnets mounted on opposite sides of an exemplary non-magnetic conduit may face each other with opposite poles and other remaining pair of slab magnets may face each other with similar poles, which will be discussed.

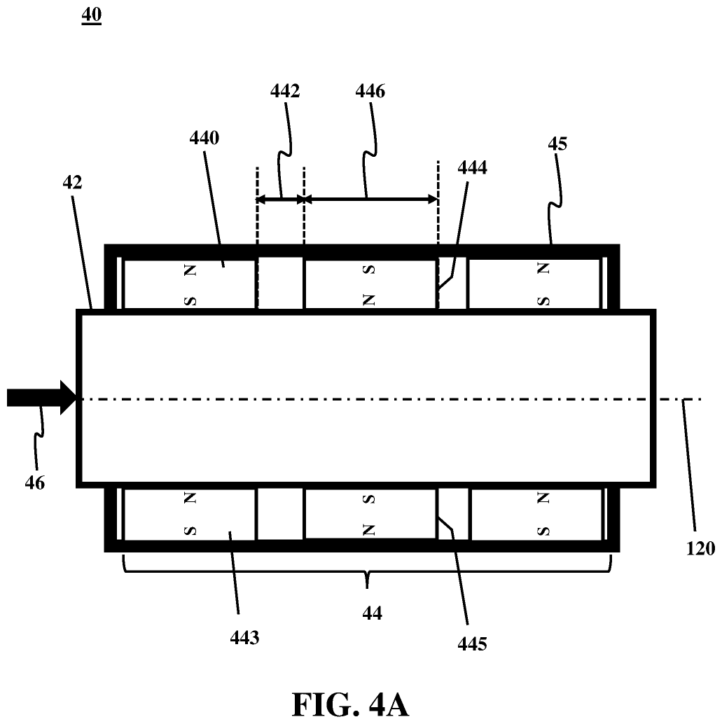

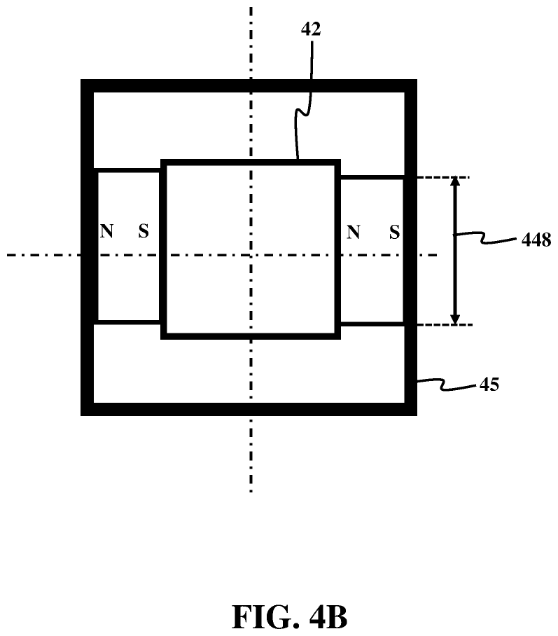

FIG. 4A illustrates a schematic sectional side view of a system 40 for magnetizing water utilizing slab magnets, consistent with one or more exemplary embodiments of the present disclosure. FIG. 4B illustrates a schematic sectional front view of system 40 for magnetizing water utilizing slab magnets, consistent with one or more exemplary embodiments of the present disclosure.

In an exemplary embodiment, system 40 may be configured similar to system 10 to apply magnetic fields on a water stream. In an exemplary embodiment, system 40 may include a non-magnetic conduit 42 similar to non-magnetic conduit 12, which may be configured for allowing a water stream to pass through non-magnetic conduit 42. In an exemplary embodiment, system 40 may further include a plurality of slab magnets 44 that may be mounted on both sides of non-magnetic conduit 42. In an exemplary embodiment, plurality of slab magnets 44 may be mounted along a length of non-magnetic conduit 42 with a predetermined longitudinal distance between each pair of adjacent slab magnets of plurality of slab magnets 44. For example, slab magnet 440 may be mounted at a predetermined longitudinal distance 442 from slab magnet 444. In an exemplary embodiment, predetermined longitudinal distance 442 may be between a quarter of a width 448 of each slab magnet and a half of width 448. In an exemplary embodiment, each slab magnet may have a predetermined length 446, which may depend at least in part on a total length of non-magnetic conduit 42.

In an exemplary embodiment, each pair of slab magnets on either sides of non-magnetic conduit 42 may be aligned along an axis perpendicular to longitudinal axis 420 of non-magnetic conduit 42. For example, slab magnet 440 may be aligned with slab magnet 443 at opposite sides of non-magnetic conduit 42. In an exemplary embodiment, opposite pairs of slab magnets may be polarized such that opposite poles may face towards non-magnetic conduit 42. For example, north pole of slab magnet 440 may face non-magnetic conduit 42, while south pole of slab magnet 443 may face non-magnetic conduit 42. In an exemplary embodiment, next pair of adjacent slab magnets may be polarized oppositely. For example, in the example presented above, south pole of slab magnet 444 may face non-magnetic conduit 42, while a north pole of slab magnet 445 may face non-magnetic conduit 42. In an exemplary embodiment, such arrangement of slab magnets around non-magnetic conduit 42 may allow for application of magnetic fields on a water feed 46 pumped into and passing through system 40.

In an exemplary embodiment, system 40 may further include an iron shield 45 that may be disposed around non-magnetic conduit 42. In an exemplary embodiment, iron shield 45 may extend along longitudinal axis 420 of non-magnetic conduit 42. Plurality of slab magnets 44 may be disposed between iron shield 45 and non-magnetic conduit 42. Referring to FIG. 4B, in an exemplary embodiment, iron shield 45 may have a square or rectangular cross-section that may concentrically be positioned around non-magnetic conduit 42, which also may have a square or rectangular cross-section. As used herein, a longitudinal axis of an object is an axis associated with the longest dimension of that object.

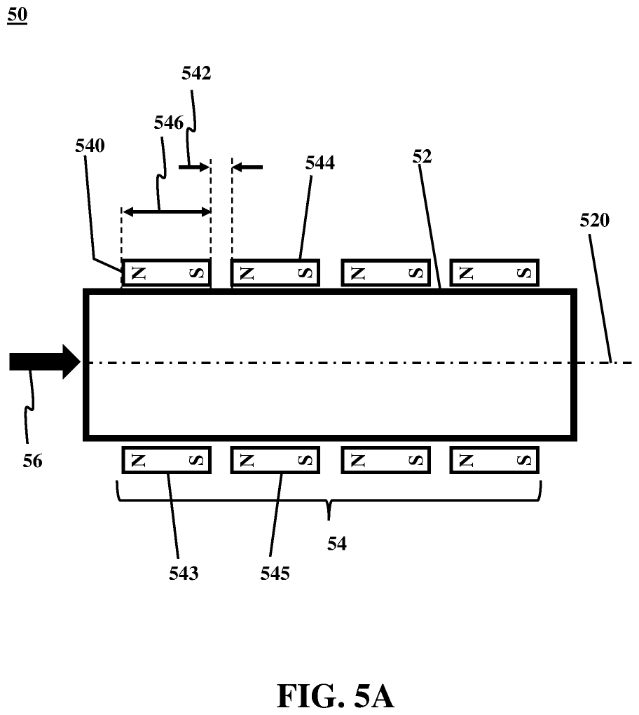

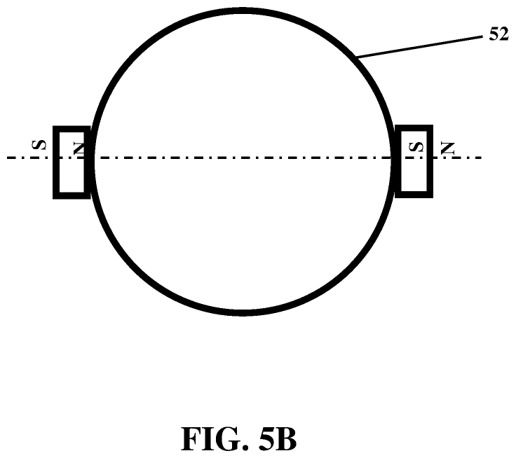

FIG. 5A illustrates a schematic sectional side view of a system 50 for magnetizing water utilizing bar magnets, consistent with one or more exemplary embodiments of the present disclosure. FIG. 5B illustrates a schematic sectional front view of system 50 for magnetizing water utilizing bar magnets, consistent with one or more exemplary embodiments of the present disclosure.

In an exemplary embodiment, system 50 may be configured similar to system 10 and system 40 to apply magnetic fields on a water feed 56. In an exemplary embodiment, system 50 may include a non-magnetic conduit 52 similar to non-magnetic conduit 12, which may be configured for allowing a water stream to pass through system 50. In an exemplary embodiment, system 50 may further include a plurality of magnet bars 54 that may be mounted on both sides of non-magnetic conduit 52. In an exemplary embodiment, plurality of magnet bars 54 may be mounted along a length of non-magnetic conduit 52 with a predetermined longitudinal distance between each pair of adjacent magnet bars of plurality of magnet bars 54. For example, magnet bar 540 may be mounted at a predetermined longitudinal distance 542 from magnet bar 544. In an exemplary embodiment, each magnet bar of plurality of magnet bars 54 may have a predetermined length 546 (referred to herein with symbol Lₘ) that may be between 20 mm and 200 mm. In an exemplary embodiment, the predetermined longitudinal distance between each pair of adjacent magnet bars of plurality of magnet bars 54 may be between Lₘ/8 and Lₘ/4.

In an exemplary embodiment, each pair of magnet bars at either sides of non-magnetic conduit 52 may be aligned along an axis perpendicular to longitudinal axis 520 of non-magnetic conduit 52. For example, magnet bar 540 may be aligned with magnet bar 543 at opposite sides of non-magnetic conduit 52. In an exemplary embodiment, plurality of magnet bars 54 may be polarized as illustrated in FIGS. 5A and 5B. In an exemplary embodiment, such arrangement of magnet bars around non-magnetic conduit 52 may allow for application of magnetic fields on water feed 56 that may flow through system 50.

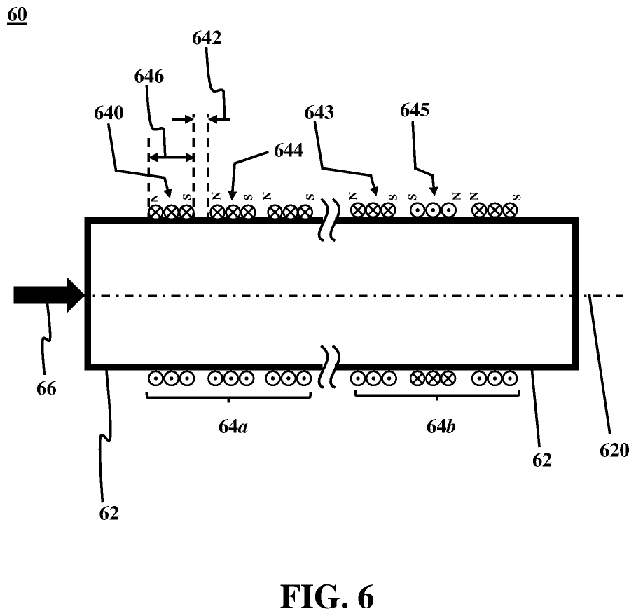

FIG. 6 illustrates a schematic sectional side view of a system 60 for magnetizing water utilizing at least one electromagnet, consistent with one or more exemplary embodiments of the present disclosure. In an exemplary embodiment, system 60 may be configured similar to systems 10, 40, and 50 to apply magnetic fields on a water feed 66. In an exemplary embodiment, system 60 may include a non-magnetic conduit 62 similar to non-magnetic conduit 12, which may be configured for allowing water feed 66 to flow through system 60. In an exemplary embodiment, system 60 may further include a plurality of electromagnets (64a, 64b) that maybe wound around non-magnetic conduit 62. Specifically, plurality of electromagnets (64a, 64b) may be wound around an outer surface of non-magnetic conduit 62. As illustrated in FIG. 6, conductive wires wound around non-magnetic conduit 62 are designated by small circles with dots and crosses inside the small circles. As used herein, the dots and crosses are indicative of the current direction. Specifically, circles with dots designate a current direction towards the view and circles with cross designate a current direction away from view. Polarities for each coil of conductive wire are further designated by N's for north poles and S's for south poles. The polarity of the electromagnet formed by each coil is determined by the current direction within that coil. For example, for coil 640 which may form an electromagnet, when viewed from the side, the current is counterclockwise and therefore the north pole (N) is at the left and the south pole (S) is at the right.

In an exemplary embodiment, plurality of electromagnets (64a, 64b) may be mounted along a length of non-magnetic conduit 62 with a predetermined longitudinal distance between each pair of adjacent electromagnet coils of plurality of electromagnets (64a, 64b). For example, electromagnet coil 640 may be mounted at a predetermined longitudinal distance 642 from electromagnet coil 644. In an exemplary embodiment, each electromagnet coil of plurality of electromagnets (64a, 64b) may have a predetermined length (Lₘ) 646 that may be between 20 mm and 200 mm. In an exemplary embodiment, the predetermined longitudinal distance between each pair of adjacent electromagnet coils of plurality of electromagnets (64a, 64b) may be between Lₘ/8 and Lₘ/4.

In an exemplary embodiment, a first plurality of electromagnets 64a may be configured such that each pair of adjacent electromagnet coils of first plurality of electromagnets 64a may be facing each other with sides having opposite polarities. For example, electromagnetic coil 640 may be facing electromagnetic coil 644 with opposite S and N polarities. In an exemplary embodiment, a second plurality of electromagnets 64b may be configured such that each pair of adjacent electromagnet coils of second plurality of electromagnets 64b may be facing each other with sides having similar polarities. For example, electromagnetic coil 643 may face electromagnetic coil 645 with similar S poles.

In an exemplary embodiment, such arrangement may be vice versa, i.e. each pair of adjacent electromagnet coils of first plurality of electromagnets 64a may be facing each other with sides having similar polarities. In an exemplary embodiment, a second plurality of electromagnets 64b may be configured such that each pair of adjacent electromagnet coils of second plurality of electromagnets 64b may be facing each other with sides having opposite polarities. However, for the sake of simplicity only one arrangement is discussed here.

According to one or more exemplary embodiments, the present disclosure is further directed to a method for magnetizing water by subjecting a water stream to magnetic fields. In an exemplary embodiment, an exemplary method for magnetizing water may include subjecting a water stream to at least one magnetic field by arranging a plurality of magnets around a conduit through which the water stream may pass. In an exemplary embodiment, plurality of magnets may be mounted along a length of the conduit with a predetermined longitudinal distance between each pair of magnets of the plurality of magnets. In an exemplary embodiment, the plurality of magnets may include at least one of a plurality of axially magnetized magnet rings, a plurality of slab magnets, a plurality of magnet bars, and an electromagnet.

As mentioned before, the produced magnetized water may have a wide range of applications. What follows is a description of an embodiment of a system for utilizing the produced magnetized water for producing a water disinfectant solution. It should be understood that the described systems and methods are just one example of how magnetized water may be utilized in different systems and different synthesis methods and improve them in a considerable fashion.

According to one or more exemplary embodiments, the present disclosure is further directed to exemplary embodiments of an exemplary water disinfectant solution production system that may include a water magnetization module and a water disinfectant production module. An exemplary water magnetization module may first magnetize water and then magnetized water may enter an exemplary water disinfectant production module. An exemplary water disinfection production module may include an electrolysis reactor that may produce a disinfectant in situ. In an exemplary embodiment, magnetizing water before feeding the water into an exemplary water disinfectant production module may have benefits that may include but are not limited to increasing the solubility of salt in water which may lead to an increase in the efficiency of water disinfectant production in an exemplary water disinfectant production module.

In an exemplary embodiment, such coupling of an exemplary water magnetization module and an exemplary water disinfection production module may allow for increasing the disinfection capability of water by increasing its solubility at a constant amount of disinfectant. In other words, the concentration of the disinfectant may be significantly decrease while its effectiveness may be maintained.

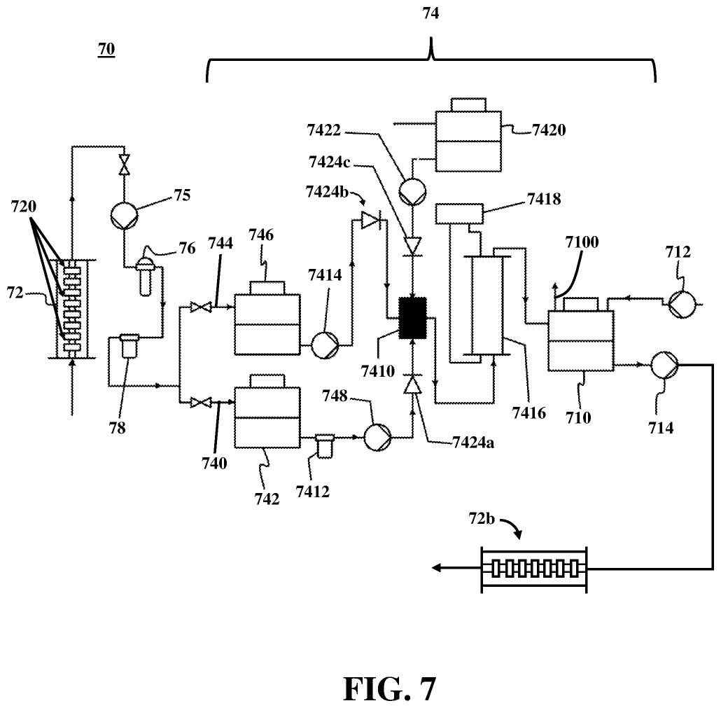

FIG. 7 illustrates a flow diagram of a water disinfectant production system 70, consistent with one or more exemplary embodiments of the present disclosure. In an exemplary embodiment, water may first pass through an exemplary water magnetization module 72, where water may be magnetized by being exposed to magnetic fields produced by either a series of permanent magnets or a series of electromagnets (720). Water magnetization may weaken hydrogen bonds in water molecules and as a result may increase solubility of salt in water. In an exemplary embodiment, magnetized water may then enter a water disinfectant production module 74 after passing through a resin softener 76 and a filter 78, which may either be a sand filter or a poly propylene cartridge filter. In an exemplary embodiment, resin softener 76 may include a cationic water softener. In an exemplary embodiment, magnetized water may be pumped utilizing a first booster pump 75 into water disinfectant production module 74.

In an exemplary embodiment, as magnetized water enters water disinfectant production module 74, a first portion 740 of the magnetized water may be injected into a brine tank 742 and a second portion 744 of magnetized water may enter a soft water tank 746. In an exemplary embodiment, brine tank 742 may include NaCl, where first portion 740 of magnetized water may be mixed with NaCl to obtain a saturated brine solution. As-produced saturated brine solution may be pumped by a metering pump 748 into a mixing chamber 7410 after passing through a brine filter 7412. In an exemplary embodiment, second portion 744 of magnetized water may be pumped by a soft water pump 7414 into mixing chamber 7410, where soft magnetized water may be mixed with saturated brine solution and then may be fed into an electrolysis reactor 7416.

In an exemplary embodiment, electrolysis reactor 7416 may include a cylindrical or cubic chamber, in which cathode and anode electrodes as a bipolar or monopolar unit or a combination of both may be used in a parallel fashion for performing electrolysis. In an exemplary embodiment, anode and cathode electrodes may be made of titanium with or without a cover. In an exemplary embodiment, anode and cathode electrodes may be made of carbon or steel. In an exemplary embodiment, anode and cathode electrodes may of electrolysis reactor 7416 may be connected to at least one power supply 7418, where the necessary electric voltage for the electrolysis of brine solution may be provided by at least one power supply 7418. Existing salt in water may turn into hypochlorite or hydrogen anions after passing through the electric field and hydrogen gets released as a gas and finally disinfectant solution may be produced. In fact, electrolysis of water minerals including NaCl may take place when the saturated brine solution passes through electrolysis reactor 7416 and as a result disinfectant substance including NaOCl, HOCl, H₂O₂, ClO₂, soluble ozone and oxygen may be produced. These substances accelerate and strengthen the disinfection procedure. pH of the solution in outlet is neutral. Density of the produced disinfectant solution is between 50 to 5000 milligrams per liter.

In an exemplary embodiment, mixing chamber 7410 may be utilized for controlling the pressure and metering of softened water pumped from soft water tank 746 and saturated brine solution pumped from brine tank 742. Soft water and saturated brine solution may enter mixing chamber 7410 before entering electrolysis reactor 7416 and the distribution of salt ions in water volume becomes homogeneous due to whirlpool movements within mixing chamber 7410. In case of necessity, any additives or other necessary substances can be injected into mixing chamber 7410 through an additive tank 7420 with the help of an additive metering pump 7422. All piping and fluid communication lines between an exemplary tank (either one of soft water tank 746, brine tank 742, or additive tank 7420) and mixing chamber 7410 may be intercepted by one-way valves, such as valves 7424a-c so as to prevent fluids to flow back from mixing chamber 7410. Outlet water from electrolysis reactor 7416 may enter a disinfectant solution reservoir tank 710 and hydrogen gas may be evacuated through a vent 7100. In an exemplary embodiment, a blower 712 may be utilized for injecting air into reservoir tank 710 to accelerate hydrogen evacuation through vent 7100.

In an exemplary embodiment, water disinfectant production system 70 may further include a second water magnetization module 72b that may be structurally similar to water magnetization module 72. In an exemplary embodiment, magnetized disinfectant solution from disinfectant solution reservoir tank 710 may further pass through second water magnetization module 72b and may further be subjected to magnetic fields before being pumped back into disinfectant solution reservoir tank 710.

For simplicity, only one embodiment of water magnetization module 72 and second water magnetization module 72b are illustrated in FIG. 7. In exemplary embodiments, water magnetization module 72 and second water magnetization module 72b may be configured similar to at least one of systems 10, 40, 50, and 60.

In exemplary embodiments, benefits of utilizing water disinfectant production system 70 of exemplary embodiments of the present disclosure may include but are not limited to leaving free active chlorine in long water networks, removal of taste stink from water, high durability, reduction in using disinfectant substance due to its strong impact, fast disinfection, removal of many resistant microorganism to disinfectants including Cryptosporidium, reduction of production of Trihalomethanes and hollow Acetic acid at disinfecting surface water containing minerals, cheap accessible raw material, greater safety while production, maintenance and consumption, production of disinfecting magnetized water without chemical substances, simultaneous destroying of biofilm from chambers' casing and water transmission networks organically without chemical substances, and no need to poisonous substance for the disinfection due to salt electrolysis method.

According to one or more exemplary embodiments of the present disclosure, an exemplary water disinfectant production system may have applications in poultry farms, livestock farms, animal husbandry farms, fish farms, small and big industries consuming magnetized water for sterilizing, and disinfecting flower and seed conservatories, and bushes, tree, vegetables and fruit conservatories. It is also useful in disinfecting drinking water, pool water, aqua parks, sewage treatment, industrial water including cooling towers, desalination, surface disinfection, clothes, dishes and etc.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

What is claimed is:

1. A system for magnetizing water, comprising:
a non-magnetic conduit configured to allow a stream of water to flow therethrough; and
a magnetic fields generation mechanism comprising a plurality of magnets arranged around the non-magnetic conduit, the magnetic fields generation mechanism configured to subject the stream of water to magnetic fields.

2. The system of claim 1, wherein the magnetic field generation mechanism comprises a plurality of axially magnetized permanent magnet rings, each permanent magnet ring fitted coaxially around the non-magnetic conduit, the plurality of axially magnetized permanent magnet rings mounted along a length of the non-magnetic conduit with a predetermined longitudinal distance between each pair of adjacent axially magnetized permanent magnet rings of the plurality of axially magnetized permanent magnet rings.

3. The system of claim 2, wherein the plurality of axially magnetized permanent magnet rings are mounted on the non-magnetic conduit with an axis of symmetry of each axially magnetized permanent magnet ring of the plurality of axially magnetized permanent magnet rings parallel with a longitudinal axis of the non-magnetic conduit, a central hole of each axially magnetized permanent magnet ring of the plurality of axially magnetized permanent magnet rings encompassing the non-magnetic conduit.

4. The system of claim 3, wherein each axially magnetized permanent magnet ring of the plurality of axially magnetized permanent magnet rings comprises a first face with a first polarity and a second face with a second polarity, the first face and the second face perpendicular to the axis of symmetry of the permanent magnet ring.

5. The system of claim 4, wherein each pair of adjacent axially magnetized permanent magnet rings of the plurality of axially magnetized permanent magnet rings are facing each other with faces having opposite polarities.

6. The system of claim 4, wherein each pair of adjacent axially magnetized permanent magnet rings of the plurality of axially magnetized permanent magnet rings are facing each other with faces having similar polarities.

7. The device of claim 4, wherein the plurality of axially magnetized permanent magnet rings comprises:
a first axially magnetized permanent magnet ring; and
a second axially magnetized permanent magnet ring positioned at the predetermined longitudinal distance away from the first axially magnetized permanent magnet ring, wherein, a first face of the first axially magnetized permanent magnet ring with a first polarity is positioned facing a second face of the second axially magnetized permanent magnet ring with a second polarity, the first polarity and the second polarity are opposite polarities.

8. The system of claim 7, wherein an inner diameter of each axially magnetized permanent magnet ring of the plurality of axially magnetized permanent magnet rings is equal to an outer diameter of the non-magnetic conduit.

9. The system of claim 7, further comprising an elongated housing coaxially disposed around the non-magnetic conduit, the elongated housing extended along the longitudinal axis of the non-magnetic conduit, the elongated housing coaxial with and encompassing the plurality of axially magnetized permanent magnet rings such that the plurality of axially magnetized permanent magnet rings are disposed between the elongated housing and the non-magnetic conduit.

10. The system of claim 1, wherein the magnetic field generation mechanism comprises a plurality of slab magnets arranged around the non-magnetic conduit, the plurality of slab magnets mounted along a length of the non-magnetic conduit with a predetermined longitudinal distance between each pair of adjacent slab magnets of the plurality of slab magnets.

11. The system of claim 10, wherein each slab magnet of the plurality of slab magnets is mounted between an outer surface of the non-magnetic conduit and an inner surface of an iron shield.

12. The system of claim 11, wherein the plurality of slab magnets comprise pairs of slab magnets mounted on opposite sides of the outer surface of the non-magnetic conduit with each pair of oppositely mounted slab magnets facing each other with opposite poles.

13. The system of claim 1, wherein the magnetic field generation mechanism comprises a plurality of magnet bars arranged around the non-magnetic conduit, the plurality of magnet bars mounted along a length of the non-magnetic conduit with a predetermined longitudinal distance between each pair of adjacent magnet bars of the plurality of magnet bars.

14. The system of claim 13, wherein the magnetic field generation mechanism further comprises a plurality of magnet bars mounted within the non-magnetic conduit along the length of the non-magnetic conduit.

15. The system of claim 1, wherein the magnetic field generation mechanism comprises a plurality of electromagnet coils arranged around the non-magnetic conduit, the plurality of electromagnet coils mounted along a length of the non-magnetic conduit with a predetermined longitudinal distance between each pair of adjacent electromagnet coils of the plurality of electromagnet coils.

16. The system of claim 15, wherein the magnetic field generation mechanism further comprises a plurality of electromagnetic coils mounted on a magnet support within the non-magnetic conduit along the length of the non-magnetic conduit.

17. A method for magnetizing water, the method comprising:
generating a magnetic field in a stream of water by arranging a plurality of axially magnetized permanent magnet rings around a conduit through which the stream of water passes, each permanent magnet ring of the plurality of axially magnetized permanent magnet rings fitted coaxially around the conduit, the plurality of axially magnetized permanent magnet rings mounted along a length of the conduit with a predetermined longitudinal distance between each pair of adjacent axially magnetized permanent magnet rings of the plurality of axially magnetized permanent magnet rings.

18. The method of claim 17, wherein arranging the plurality of axially magnetized permanent magnet rings around the conduit comprises arranging the plurality of axially magnetized permanent magnet rings such that each pair of adjacent axially magnetized permanent magnet rings of the plurality of axially magnetized permanent magnet rings are positioned at a predetermined longitudinal distance from each other and facing each other with faces having opposite polarities.

19. The method of claim 17, wherein arranging the plurality of axially magnetized permanent magnet rings around the conduit comprises arranging the plurality of axially magnetized permanent magnet rings such that each pair of adjacent axially magnetized permanent magnet rings of the plurality of axially magnetized permanent magnet rings are positioned at a predetermined longitudinal distance from each other and facing each other with faces having similar polarities.

20. The method of claim 17, wherein arranging the plurality of axially magnetized permanent magnet rings around the conduit comprises arranging the plurality of axially magnetized permanent magnet rings such that each pair of adjacent axially magnetized permanent magnet rings of the plurality of axially magnetized permanent magnet rings are positioned at a predetermined longitudinal distance between 2 mm and 10 mm from each other.
